(19) United States
(12) Patent Application Publication
(10) Pub. No.: US 2005/0288475 A1
(43) Pub. Date: Dec. 29, 2005

(54) Pressure and temperature sensitive material

(76) Inventor: Marvine P. Hamner, Frederick, MD (US)

Correspondence Address: Lieberman & Brandsdorfer, LLC, 12221 McDonald Chapel Drive, Gaithersburg, MD, 20878, US

(21) Appl. No.: 11/138,304

(22) Filed: May 27, 2005

Related U.S. Application Data
(60) Provisional application No. 60/582,789, filed on Jun. 25, 2004.

(51) Int. Cl. C08G 18/00

(52) U.S. Cl. 528/44

(57) ABSTRACT

A polymeric material which exhibits an optically detectable response to changes in pressure and temperature.

### CROSS REFERENCE TO RELATED APPLICATION(S)

This is a non-provisional utility patent application claiming benefit of the filing date of U.S. provisional application Ser. No. 60/582,789 filed Jun. 25, 2004, and titled Pressure and Temperature Sensitive Material.

### TECHNICAL FIELD

This invention relates to polymeric material useful in acquiring quantitative measurement of loads and temperature. More specifically, the invention relates to synthesis of a nano-material which exhibits an optically detectable response to changes in loads (such as pressure or shear stress) and temperature.

### DESCRIPTION OF THE PRIOR ART

Acquisition of quantitative data representing global, surface pressure by non-intrusive optical methods is well known in the literature. Techniques used for the acquisition of these data range from detection of Raman scattering to pressure sensitive coatings commonly called pressure sensitive paints. Traditionally, pressure sensitive paints (PSP) consist of a host matrix in which one of a variety of chromophores is encapsulated. The host matrix is often a polymeric material such as polydimethylsiloxane (PDMS), but other materials such as sol-gels have been used. Typical chromophores used have included platinum octaethylporphyrin (PtOEP) and ruthenium-based complexes which have a very high degree of oxygen sensitivity. The functionality of these pressure sensitive paints depends on the dynamic quenching of the chromophore's luminescent emission by oxygen. In order for this dynamic quenching to be effective the host matrix must allow the diffusion of oxygen throughout the “paint” to the chromophores. One example of a prior art application requiring the diffusion of oxygen is U.S. Pat. No. 5,965,632 to Gouterman which teaches the use of a pressure sensitive paint incorporating an acrylic and flouroarcrylic polymer binder. A pressure sensing dye is dissolved or dispersed in the polymer matrix. Emission from the dyes is quenched in the presence of molecular oxygen. Similarly, in a prior non-related application to Kelley et al., the pressure sensitive material used has a host polymer and fluorescent compounds attached to the host polymer. The host polymer has a rubber like” characteristic rather than a rubbery elastomer. In addition, Kelly et al. focuses on the use of polystyrene because it does not contain oxygen. Accordingly, one of the limitations of the prior art pressure sensitive paints is the sensitivity to oxygen.

Dynamic quenching by oxygen follows an association known as the Stern-Volmer relationship. This relationship between changes in luminescent emission intensity, I, and the local partial pressure of oxygen, pₒ, is expressed as Iₒ/I=A+B(p/pₒ) where A=kₐ/(kₐ+k_{q}pₒ) and B=k_{q}pₒ/(kₐ+k_{q}pₒ). In these equations Iₒ is the incident excitation light intensity, kₐ is the intrinsic de-excitation rate in the absence of oxygen, k_{q} is the quenching rate due to collisions with oxygen and p is the local pressure. In addition, A+B=1. A typical plot of the relationship between changes in luminescent emission intensity and local partial pressure of oxygen is shown in FIG. 1. Under the conditions normally experienced during high-speed tests (e.g. supersonic), systems following the Stern-Volmer relationship exhibit relatively large changes in emission intensity for only small changes in pressure. However, the same systems used for low-speed (e.g. atmospheric) tests exhibit only extremely small changes in emission intensity even for large changes in pressure. This is shown schematically in FIG. 2 which is a graph showing the Stern-Volmer relationship between small changes in intensity and large changes in pressure. In addition, systems following the Stern-Volmer relationship exhibit decreasing emission intensity with increasing pressure due to the quenching process. Accordingly, this results in lower signal to noise ratios with the maximum signal to noise ratio at vacuum, or near vacuum, conditions.

Because these systems rely on oxygen quenching to vary emission light intensity with changes in pressure, any perturbation to the host matrix' oxygen permeability alters the pressure sensitive paint's performance. For example, variations in humidity and/or temperature affect pressure sensitive paint's performance. Unfortunately, even the oils normally found on human skin have been known to affect the performance of some traditional pressure sensitive paint formulations making handling of painted test articles difficult. Accordingly, there is a need for a pressure sensitive material that mitigates sensitivity to oxygen.

The quantitative determination of pressure begins by detecting the emission intensity of the pressure sensitive paint using a scientific grade charge coupled device (CCD) camera, a photodiode, a photomultiplier or any other typical optical signal detector. Because non-uniformities may exist in either the excitation light, or illumination, or in the paint application itself, the detected emission intensity is ratioed with a “reference” intensity. The ratioing process eliminates these “real-world” effects from the measured pressure. Then a calibration is applied to the intensity ratio. The requirement for a “reference” intensity adds to the overall cost and complexity of this method.

Temperature sensitive formulations are also well known in the literature. Traditionally they are mixtures comprised of temperature sensitive chromophores dissolved in polymer solutions. These temperature sensitive formulations are also traditional in their functionality. That is, beyond consideration of their quantum efficiency, their emission intensity typically follows the Beer-Lambert law given as:
I=Iₒ(1−e^{εcl})
where I is the emission intensity of the paint, Iₒ is the incident radiant intensity, ε is the extinction coefficient of the chromophore, c is the chromophores concentration and l is a characteristic length. Assuming the quantum efficiency to be fixed for a given chromophore, this equation indicates that the paint's emission intensity can be increased by increasing the incident radiant intensity, i.e. the excitation light intensity. This is true up to the point that the excitation light begins to photodegrade the paint.

However, this equation says nothing about the temperature dependence of these formulations which typically depends on an Arrhenius relationship as given by the equation:
ln(I(T)/I_{ref}(T_{ref}))=(E/R_{g})(1/T−1/T_{ref})
where I(T) is the measure emission intensity as a function of temperature, I_{ref}(T_{ref}) is a reference intensity acquired at the reference temperature in Kelvin, E is the Arrhenius activation energy, and R_{g} is the universal gas constant. This relationship shows the decrease in emission intensity with an increase in temperature. The mechanism for this process is the photochemistry involved in temperature sensitive paint (TSP); that is, the thermal pathways to de-excitation of the paint are the means by which the paint emission is reduced as temperature increases.

Materials that are pressure sensitive are also known to be temperature sensitive. A great deal of work has been done to make either a temperature compensating pressure sensitive paint or temperature correction(s) to traditional PSP's. A limitation of temperature compensating pressure sensitive paints developed so far is the limited range of temperatures they operate over. Traditional PSP's suffered because the pressure sensitive molecule was temperature sensitive and the oxygen permeability of the host matrix was also temperature sensitive. As temperature varied the host matrix would become more, or less, oxygen permeable thus enhancing or inhibiting the photochemical reaction, i.e. oxygen quenching.

Use of measured temperatures for correction of pressure measurements requires two steps. First, calibration data is acquired that is a function of both pressure and temperature. That is, pressure data is acquired at a number of different, constant temperatures. Then, an equation representing a calibration that is a function of both pressure and temperature can be applied to data acquired during testing. For example, if data acquired indicates that the emission intensity decreases with temperature as T^{0.95} and the pressure calibration is a linear function of the intensity ratio then the overall calibration equation might look like
P=aI+b−T^{0.95}
where: P represents pressure; a and b are coefficients from the curve fit of the calibration data; I is the emission intensity ratio; and, T is temperature determined from the embedded temperature sensitive molecules. This is illustrated in FIG. 9. In order to apply this type of temperature correction, data should be acquired that indicates the actual temperature of the pressure sensitive paint during operating or test conditions. This can be accomplished using a variety of instrumentation, e.g. thermocouples which measure temperature at discrete points or traditional temperature sensitive paint. Limitations of these methods include the fact that only discrete temperature measurement is available, e.g. in the case of thermocouples, so that the temperature is not measured everywhere the pressure sensitive paint is or will be applied and the fact that they do not measure the actual temperature of the pressure sensitive paint during testing, e.g. they are under the pressure sensitive paint or in another physical location.

### SUMMARY OF THE INVENTION

This invention comprises a nano-material adapted to exhibit an optically detectable response to changes in pressure and temperature.

In one aspect of the invention, a composition is provided having a polyurethane formed from precursors including polyol, an aliphatic diisocyanate and an exciplex or a FRET system. A temperature sensitive chromophore which exhibits an optically detectable response to change in temperature is also provided. The exciplex or FRET contains an analog or homolog, which contains a functional group adapted to react with either the polyurethane or its prescursors. In addition, the composition exhibits an optically detectable response to changes in pressure and temperature.

In another aspect of the invention, a coating on a surface is provided with a temperature sensitive chromphore to exhibit an optically detectable response to changes in pressure and temperature. The coating is formed from a solution of polyol, an aliphatic diisocyanate and an exciplex or FRET system. The exciplex or FRET contains an analog of homolog which a functional group adapted to react with either the polyurethane or its prescursors.

In yet another aspect of the invention, a surface coated with a composition is provided with a polyurethane formed from precursors including polyol, an aliphatic diisocyanate and an exciplex or FRET system. The exciplex or FRET contains an analog or homolog, which contains a functional group adapted to react with either the polyurethane or its precursors. The composition includes a temperature sensitive chromophore to exhibit an optically detectable response to changes in pressure and temperature.

In an even further aspect of the invention, a polyacrylate composition is provided formed from butyl acrylate or methyl methacrylate, and an analog or homolog containing a functional group adapted to react with either the polyacrylate. In addition, the composition includes a temperature sensitive chromophore for exhibiting an optically detectable response to changes in pressure and temperature.

In a yet further aspect of the invention, a coating on a surface is provided with a temperature sensitive chromphore to exhibit an optically detectable response to changes in pressure and temperature. The coating is formed from a composition formed from butyle acrylate or methyl methacrylate, and an an analog of homolog in the form an exciplex or a FRET. The analog or homolog contains a functional group adapted to react with the polyacrylate.

In another aspect of the invention, a surface coated with a composition is provided with a polyacrylate formed from butyl acrylate or methyl methacrylate, and an analog or homolog in the form of an exciplex or FRET. The analog or homolog contains a functional group adapted to react with the polyacrylate. The composition includes a temperature sensitive chromophore to exhibit an optically detectable response to changes in pressure and temperature.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a prior art graph illustrating the relationship between changes in luminescent emission intensity and local partial pressure of oxygen.

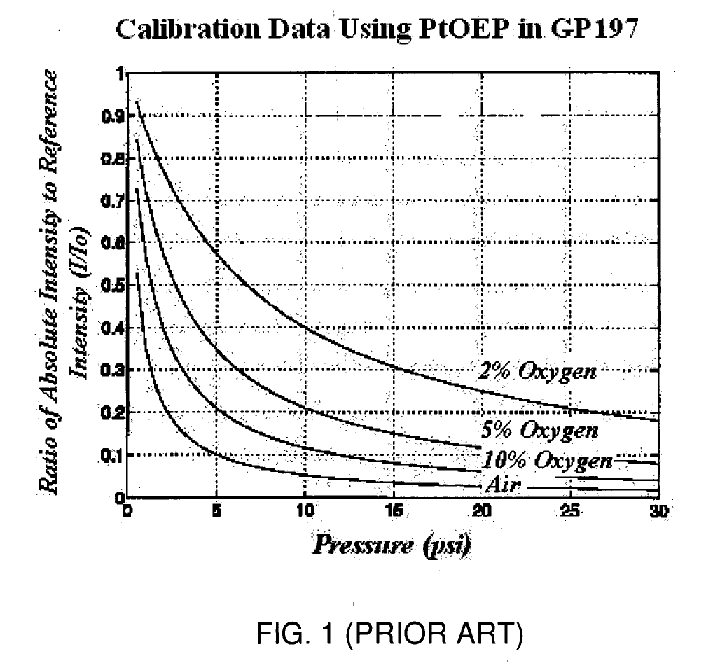

FIG. 2 is a prior art graph illustrating the Stern-Volmer relationship between small changes in intensity and large changes in pressure.

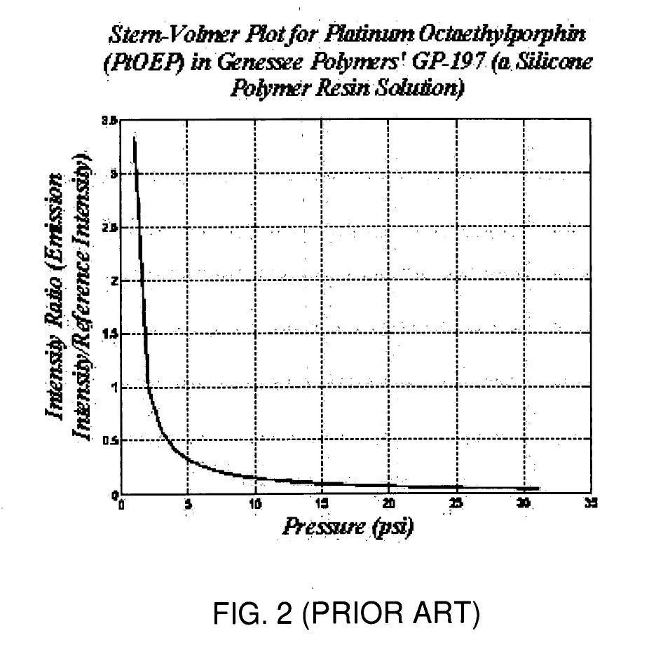

FIG. 3 is a graph illustrating of a typical spectral response of an exciplex forming system.

FIG. 4 is a graph illustrating the change in spectral response with changes in pressure.

FIG. 5 is a prior art graph illustrating a ratiometric pressure sensitive paint response to changes in pressure.

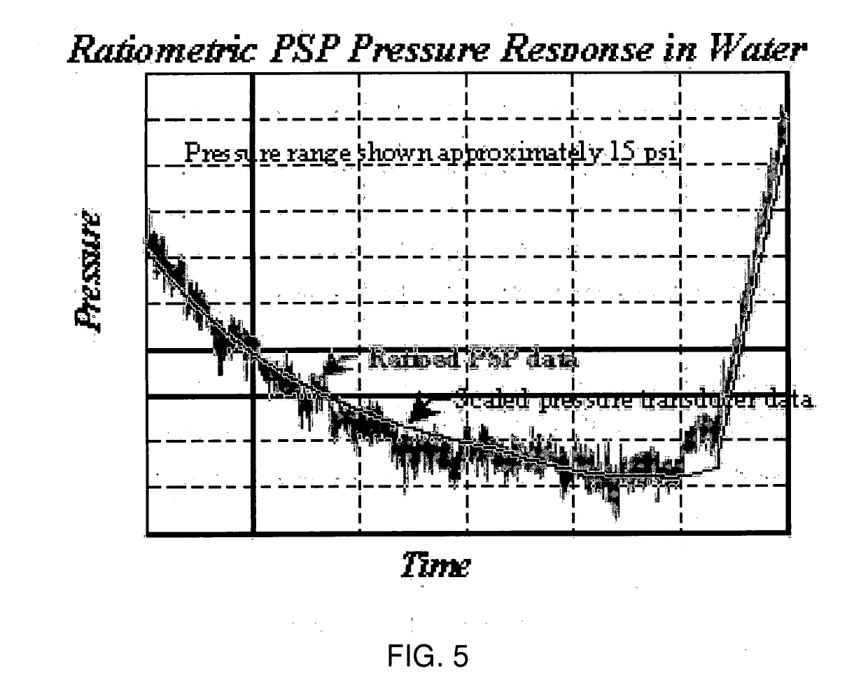

FIG. 6 is graph illustrating a FRET emission spectra according to the preferred embodiment of this invention, and is suggested for printing on the first page of the issued patent.

FIG. 7 is a graph illustrating the temperature calibration of EuTTA encapsulated in a polyurethane.

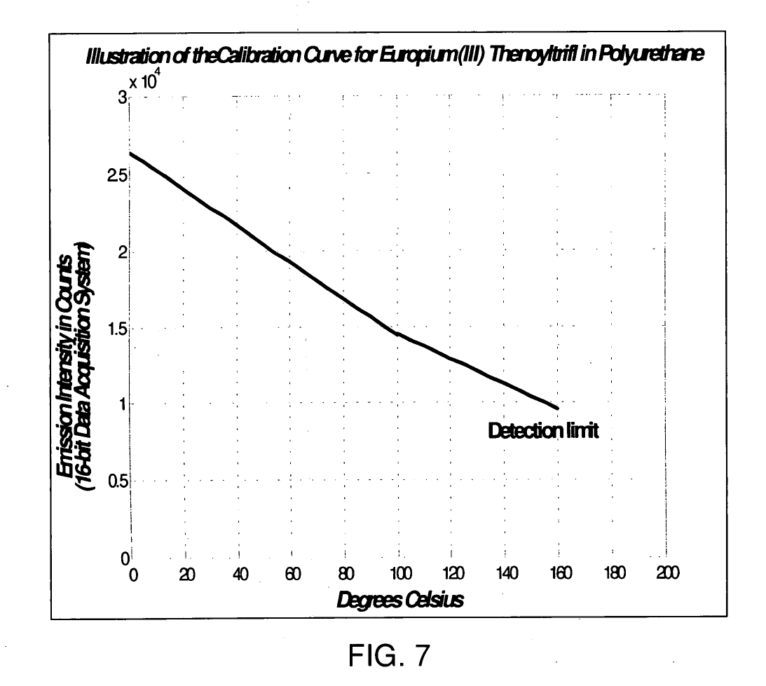

FIG. 8 is a graph pictorially illustrating the calibrated change in luminescent emission intensity with changes in surface temperature.

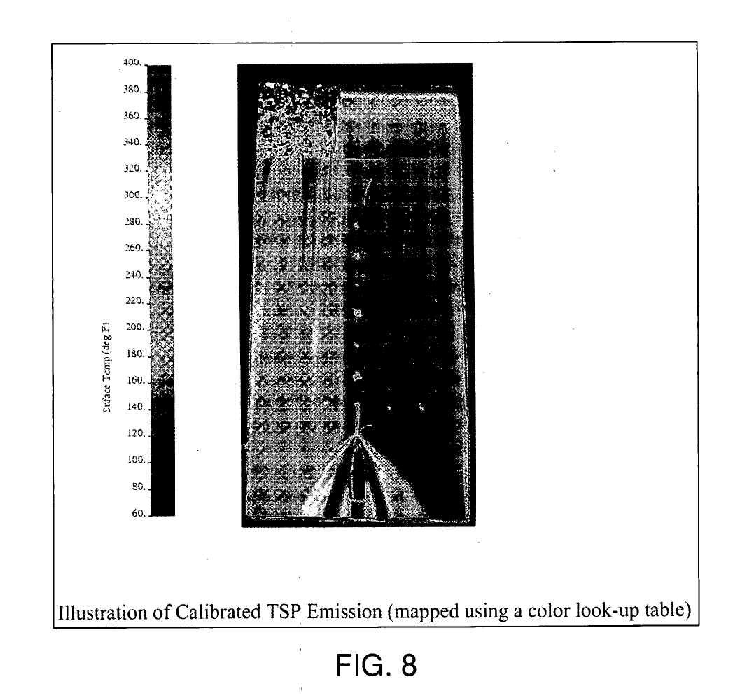

FIG. 9 is a graph pictorially illustrating an example of temperature correction applied to pressure measurements

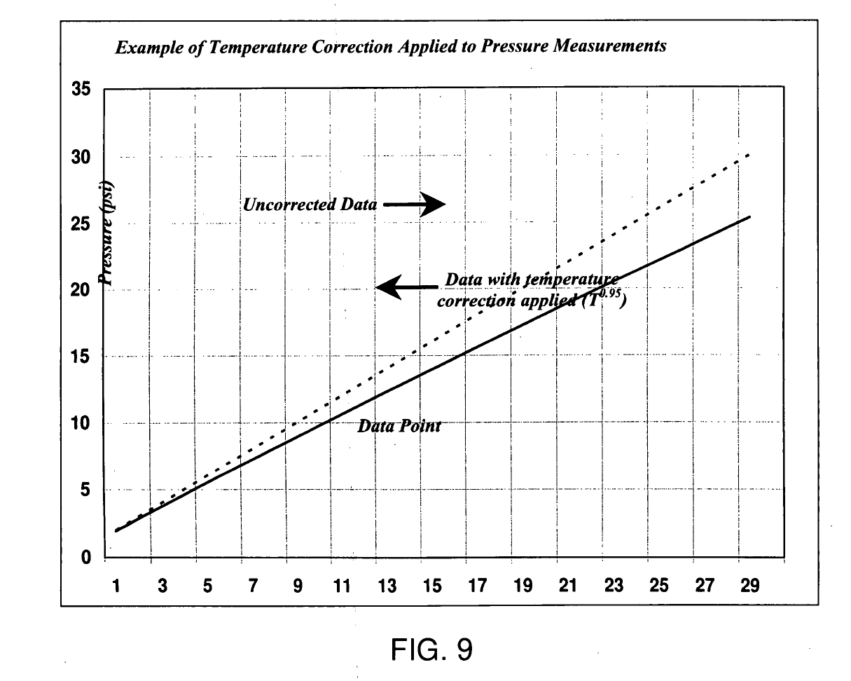

### DESCRIPTION OF THE PREFERRED EMBODIMENT

### Overview

The first embodiment of this invention concerns the development, and assembly of a pressure and temperature sensitive material at the molecular or nanoscale level. Fluorescent distance probing molecules comprising a photochemical system are copolymerized onto polymer chains during polymer synthesis. The choice of photochemical system, probes, ratio of probes, concentration of the probes and polymer, placement along the polymer chain, and the types of solvents used are parameters that are integral to performance of the material. The distance dependent photochemical system is used in this invention to measure the deformation of a polymeric material as the load (e.g. pressure) it is subjected to varies. As the material compresses or expands on the macro-scale, the polymer chains reorganize themselves in response to the changes in load and the probes report the movement. Accordingly, the movement is reported and detected by the changing emission spectrum of the polymer. This changing emission spectrum includes luminescent emission at multiple wavelengths of light. Additionally, an appropriate temperature sensitive chromophore is encapsulated in the combined formulation. The temperature sensitive chromophore reports changes in temperature through changing luminescent emission intensity over other, independent wavelengths of light. The multiple wavelengths of light emitted by the combined pressure and temperature sensitive material, any of which may be detected independently, any combination of which may be detected simultaneously, or all of which may be detected simultaneously, are used independently or in combination to determine changes in loads (pressure) and/or temperature.

### Technical Details

1. Photochemical System

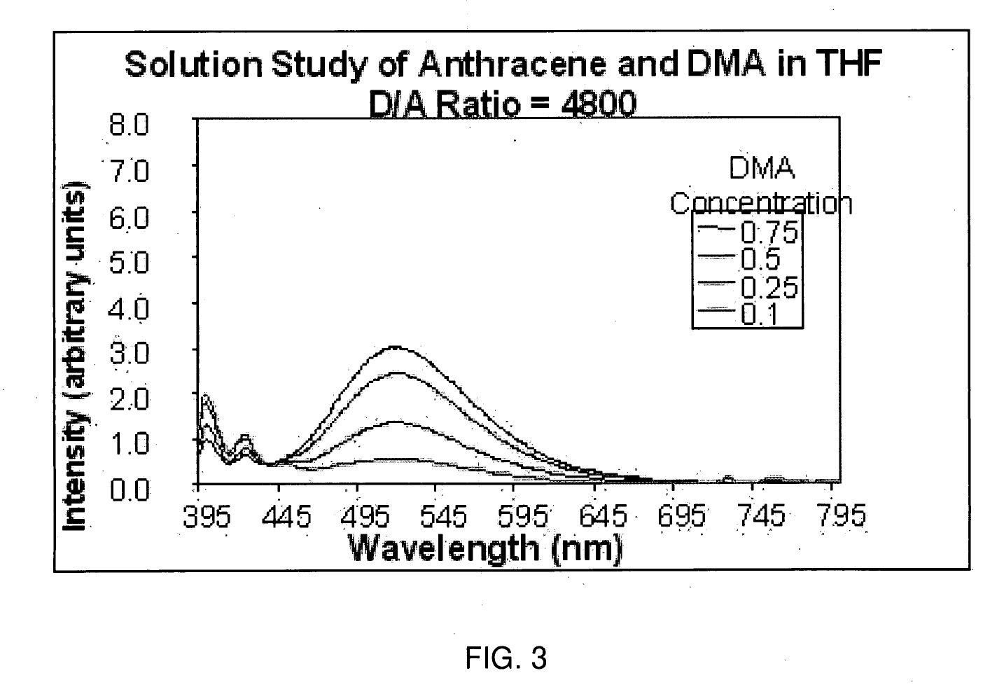

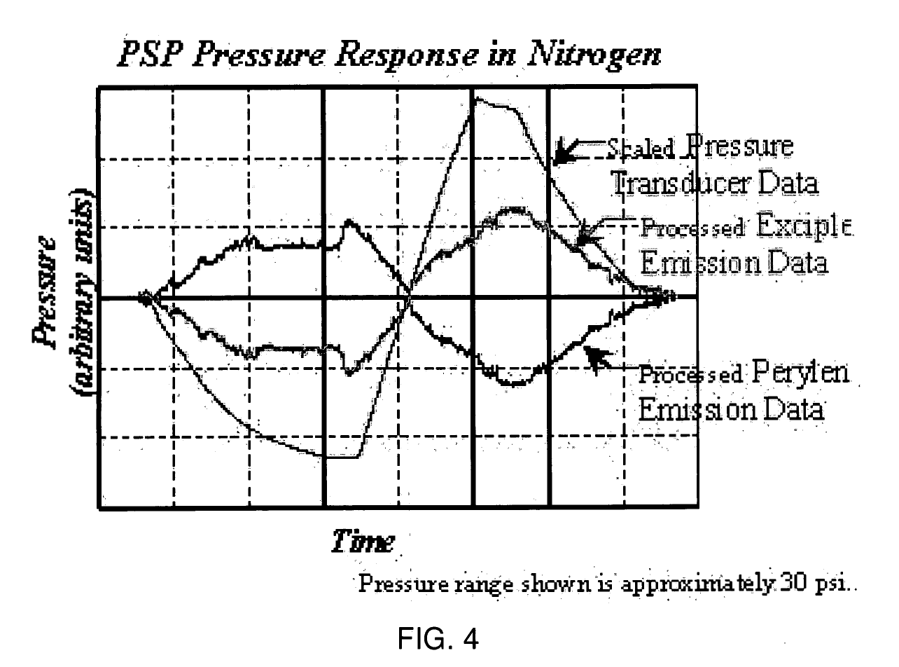

There are two forms of a photochemical systems used to detect changes in loads in this invention, an excited state complex (exciplex) and fluorescence resonance energy transfer (FRET). Both photochemical systems are reversible. These photochemical systems are distance dependent and do not rely on the presence of oxygen to operate. An exciplex (excited state complex) is the result of the formation of a charge transfer complex between an excited state fluorophore and a quencher. FIG. 3 is a graphic illustration of a typical spectral response of an exciplex forming system. In exciplex formation, an excited state fluorophore such as anthracene or perylene is quenched by an aliphatic or aromatic amine (e.g. dimethylaniline). FIG. 4 is a graphic illustration of perylene emission data and exciplex emission data. In the case of the excited state complex, an excited state fluorophore and a second appropriate fluorophore share energy. When energy is shared between a donor and an acceptor molecule, a third “excited state” compound is formed. Accordingly, the exciplex has an emission spectrum unique from the donor or acceptor. This third compound, the exciplex, luminescences over a typically red shifted broad featureless spectrum. As pressure increases more of the energy sharing occurs and the emission from the donor (e.g. Anthracene) decreases and the emission from the exciplex increases.

The exciplex formation process is distance dependent. A critical intermolecular acceptor to donor distance (˜2 Å) must be reached for emission of the complex to take place. The process is concentration dependent in solution, as well as in a solid matrix. Accordingly, donor concentrations, acceptor concentrations, and the acceptor to donor ratios are parameters that influence the emission spectra.

FRET is an alternative distance dependent photochemical system from the exciplex. In FRET, transfer of excited state energy takes place from an initially excited donor (D) to an acceptor (A). Fundamentally, the FRET donor and acceptor designation refers to energy, as opposed to the exciplex system in which the nomenclature refers to “shared” electrons. Therefore, it is required that the absorption spectrum of the acceptor must overlap the fluorescence emission spectrum of the donor for FRET to occur. The intermolecular distances required for FRET are in the order of 20 to 60 Å, which is advantageous for probing movements of macromolecules. The energy transfer in FRET takes place without the emission and re-absorption of photons, and is solely the result of dipole-dipole interactions between donors and acceptors. The FRET donor-acceptor system preferably includes a Fluorescein donor, specifically fluorescein dimethacrylate, and Rhodamine acceptor, specifically Methacryloxyethyl thiocarbamoyl rhodamine B, as shown below.

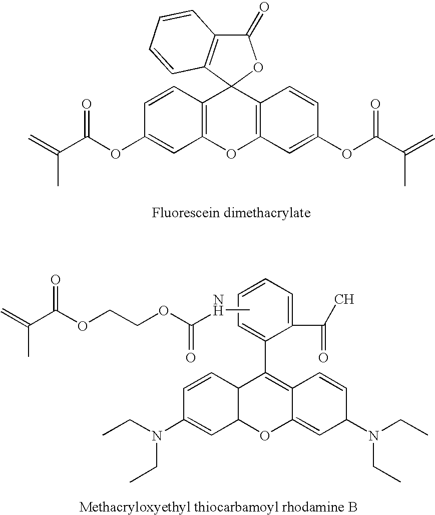

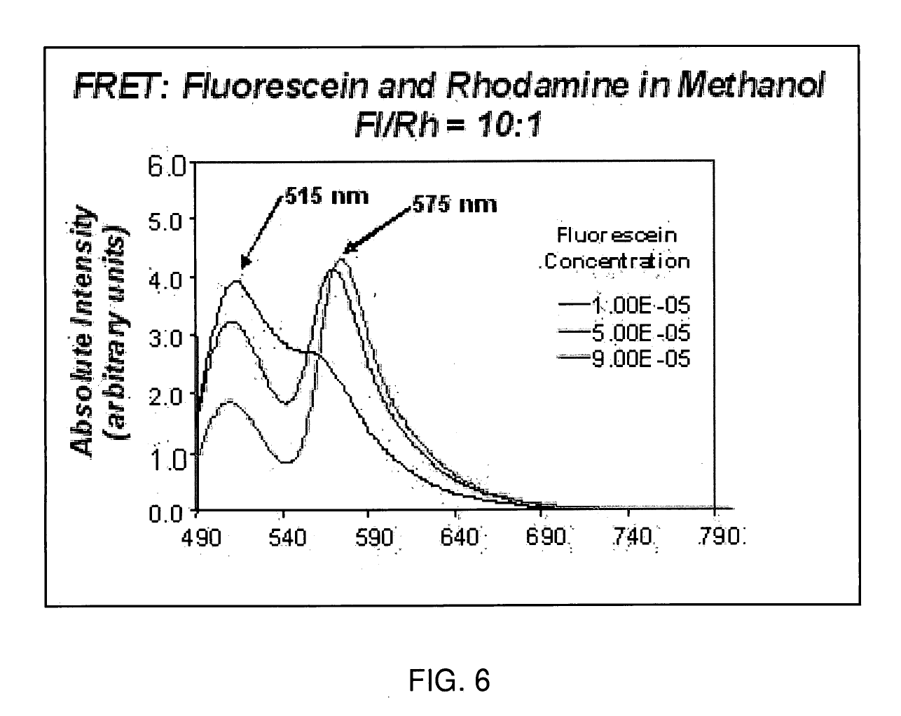

An example of the FRET emission spectra from this system is shown in FIG. 6.

The Fluorescein and Rhodamine B system has great potential as a distance dependent energy transfer system for pressure sensitive paint. The excitation wavelength that is commonly used in the Fluorescein and Rhodamine B system is 470 nm, which is compatible with existing pressure sensitive paint systems. The emission wavelengths of Fluorescein and Rhodamine B are far enough apart so that they can be optically isolated during signal detection. In FRET, the total concentration of constituent molecules is much less than what is required by the exciplex system.

During material design the luminophores can be copolymerized in low weight percentages so as to not adversely impact the material properties. Accordingly, the FRET has some additional material properties advantages over the exciplex.

2. Pressure and Temperature Sensitivity

The emissive properties of many luminescent compounds are known to exhibit pressure and temperature sensitivity. Temperature sensitive chromophores typically used include (but are not limited to):
Europium (III) Thenoyltrifl also known as EuTTA
Tris(2,2′-bipyridyl) dichloro-Ruthenium(II) hexahydrate or tris-(2,2′-bipyridine) ruthemium(II) chloride hexahydrate are known as Ru(bpy)
Ruthenium(II) bis(2,2:6,2-terpyridine) also known as Ru(trpy)
Pyronin B
Pyronin Y
Platinum Octaethyl Porphyrin also known as PtOEP; and
Chromium doped Yttrium Aluminum Garnet also known as Cr:YAG.
   Applying nano-material principles to the design and development of pressure and temperature sensitive formulations is critical to achieving the desired operation of these formulations. In designing and developing the combined pressure and temperature sensitive material described herein a systems approach is taken so that all constituents of the material and their synergistic interactions were accounted for. This involves recognizing, and either exploiting or mitigating, all photochemical reactions present. That is, the new formulation has to be considered a complex system at the molecular level, whether it involves only one sensing molecule or multiple sensing molecules which may or may not be involved directly in photochemically reactive system(s). This is in part due to the multiple conformational states that may be simultaneously assumed by the constituents of the combined pressure and temperature sensitive material. Each time a sensing chromophore's (or system of sensing chromophore's) surrounding environment changes leads to another conformational state. For example, consider the situation with traditional PSP wherein a single, oxygen-sensitive chromophore in a polymeric binder. Potential conformational states for this molecule include: partial exposure to the external environment (air) at the surface; residence in an otherwise empty cavity within the polymeric binder; co-residence in a cavity that is also occupied by solvent residuals; and, exposure to the walls of the cavities within the polymeric binder. These walls are comprised of a variety of chemical species which may include oxygen, depending on the polymer involved. These potential conformation states are related to the following photochemical reactions: dynamic quenching by oxygen; static quenching; and, relaxation in the presence of various solvents. Other photochemical reactions that may be present include: energy transfer such as resonance energy transfer (REF) and excited state reactions such as formation of an excited state complex (exciplex). In addition, non-molecular mechanisms may be present such as attenuation of the incident light through absorption by the polymeric binder or constituents of the polymer. Thus the temperature sensitivity of the combined pressure and temperature sensitive material is determined from a “systematic approach” accounting for all possible reactions and/or interactions between the temperature sensitive chromophores and their environment, e.g. other constituents of the material they are encapsulated in.
   3. Materials

The luminescent pressure and temperature sensor described herein is a coating based on polymers such as polyurethanes, polyacrylates, and silicones. Specialty monomers which are specific to the exciplex or FRET systems are copolymerized during polymer synthesis. Specialty monomers forming exciplex photochemical systems may include modified aniline, perylene and anthracene derivatives to enable binding onto the polymer. Anthracene is a solid polycyclic aromatic hydrocarbon consisting of three benzene rings derived from coal-tar. It is colorless but exhibits a blue fluorescence when excited with ultraviolet light typically centered at 365 nm. Anthracene and one form of modified anthracene are shown below. 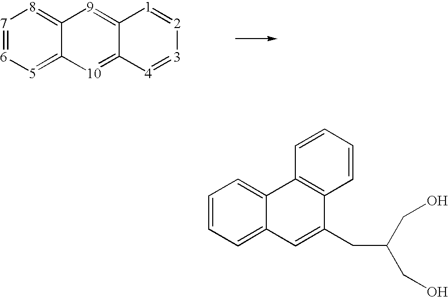
Modifications to anthracene are known in the art. See Smet et al. “Synthesis of Novel Dendritic Molecules Based on Pyrroloanthrecene units”. Perylene and one form of modified perylene used by the Applicant is shown below. 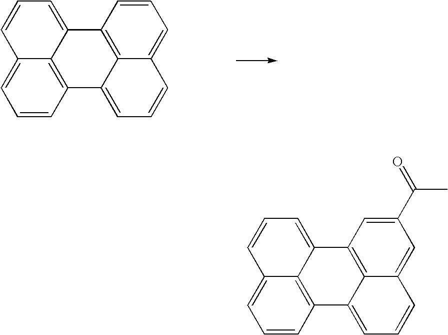
Applicant's invention should not be limited to the examples of the modified molecules shown herein. Other forms of modified anthracene and perylene may be used that support the luminescent and/or temperature sensitive properties when bonding onto the polyurethane, polyacrylate, and silicones.

The modified anthrecene or perylene are quenched by a modified aliphatic or aromatic amine. Aniline is an organic chemical compound which is a primary aromatic amine consisting of a benzene ring and an amino group. Aniline is a carcinogen that can be oxidized and resnified in air to form impurities which can give it a red-brown tint. 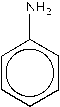
Modifications to aniline are known in the art. Three forms of modified aniline used by Applicant are shown below from left to right, Dimethylaniline (DMA), Dimethlaniline diol (DMAD), specifically 2-(4-Dimethylaminobenzyl)-propane-1,3-diol, and Dimehtyl-p-toluidine (DPT). 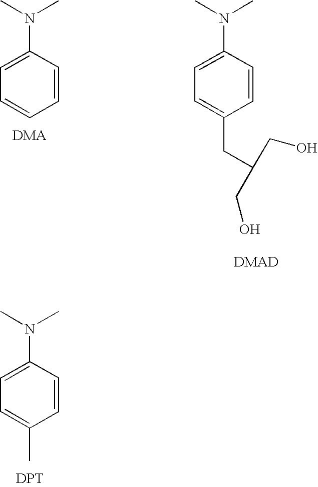
During experimentation it was found that DPT and DMAD result in lower emission ratios than DMA. A lower emission ratio corresponds to less exciplex formation. It is known in the literature that various donor derivatives have different efficiencies in the energy transfer process. See Smet et al. “Synthesis of Novel Dendritic Molecules Based on Pyrroloanthrecene units”. Applicants invention should not be limited to the examples of the modified aniline shown herein. Other forms of modified aniline may be used that support the luminescent and/or temperature sensitive properties when bonding onto the polyurethane, polyacrylate, and silicones. See variation presented in Iida et al. “Cyclocondensation of Oxalyl Chloride with 1,2-Glycols”.

A host material is provided for sensing pressure and temperature. For example, a “host” material might be a polyurethane elastomer. This material typically includes an aliphatic diisocyanate, a hydroxyl terminated polyol, and a photochemical system modified to be a chain extending diol. Constituents of photochemical systems, e.g. including but not limited to various aniline, perylene, or anthracene analogs are purchased after they have been structurally modified as appropriate for polymerization onto the host material. For example the monomers required for the exciplex-based photochemical system comprised of perylene and aniline derivatives, specifically 2-3-perylenylmethylene) 1,3-propane diol and 2-(4-Dimethylaminobenzyl)-propane-1,3-diol, were procured from Frontier Scientific in Logan, Utah. The monomers required for the FRET-based photochemical system comprised of fluorescein and rhodamine B derivatives, specifically fluorescein dimethacrylate and methacryloxyethyl thiocarbamoyl rhodamine B, were procured from Polysciences, Inc., in Warrington, Pa. Sigma-Aldrich also carries fluorescein and rhodamine B derivatives such as Fluorescein isothiocyanate isomer I and Rhodamine B octadecyl ester perchlorate. In specific embodiments described herein diols, e.g. diols of aniline, are employed. However, the diol groups may be replaced by any functional group which will react with monomer(s) used to form the elastomer.

The materials chosen for this invention are elastomeric, meaning that they possess rubber-like properties and are capable of experiencing large and reversible elastic deformations. Accordingly, the elastomeric properties of the material in combination with the reversible photochemical process form more excited charge transfer complex or FRET when the material is subject to an increase in pressure and less excited charge transfer complex or FRET as pressure is lowered.

Having the fluorescent monomers directly attached to the elastomer chains in this invention have the following significant advantages: 1) no dyes are lost during sensor use due to vaporization, sublimation, or migration to the environment, 2) aggregation of the dyes are prevented, and 3) the material properties together with the donor-acceptor ratio determine the sensitivity to pressure, and response of the luminescent load sensor.

New temperature sensitive formulations could likewise be designed and developed by processes similar to those for the new pressure sensitive nano-material formulations discussed above. However, the temperature sensitive formulations discussed herein require materials that:
1. Have excellent adhesion (basecoat-to-model and active layer-to-basecoat);
2. Have no (or non-detectable) deformations solely due to temperature;
3. Combine flexibility and durability over a wide temperature range
4. Have thermal conductivity and capacity comparable to model materials; and
5. Minimize the number of light emission wavelengths to be acquired during signal detection while maximizing the optical isolation of each individual wavelength.
   Combined Pressure and Temperature Sensitive Formulations and Synthesis:

1. Procure specialty monomers with desired optical characteristics, e.g. exciplex or FRET participating molecules with desired excitation and emission wavelengths. For example, aniline and anthracene derivatives may be used in an exciplex-based pressure sensitive system where the desired excitation wavelength can be lower than 400 nm (i.e. in the UV spectrum) and the desired emission wavelengths are in the visible spectrum (i.e. centered at 400 nm ‘blue’ and 500 nm ‘yellow’)
OR
aniline and perylene derivatives may be used in an exciplex-based pressure sensitive system where the desired excitation wavelength must be greater than 400 nm (i.e. in the visible light spectrum) and the desired emission wavelengths are also in the visible spectrum (i.e. centered at 460 nm ‘green’ and 560 nm ‘orange’)
OR
fluorescein and rhodamine B derivatives, specifically fluorescein dimethacrylate and methacryloxyethyl thiocarbamoyl rhodamine B, may be used in an FRET-based pressure sensitive system where the desired excitation wavelength must be greater than 400 nm (i.e. in the visible light spectrum) and the desired emission wavelengths are in the visible spectrum (i.e. centered at 500 nm ‘yellow’ and 560 nm ‘red’)

Note that specifying the excitation wavelength is dependent on test conditions, specifically the optical access and transmission characteristics of the facility involved. Specifying the emission wavelengths is dependent on optically isolating the coating's emission from any excitation light sources as well as the ability to detect each emission wavelength involved. All these have been tested.

2. The composition of the polyurethane elastomers includes (but are not limited to) an aliphatic diisocyanate such as isophorone diisocyanate (IPDI) or diisocyanatohexamethylene (HDI), a hydroxyl terminated polyol such as polypropylene glycol (PPG) or polytetramethylene glycol (PTMO or PTMEG), and exciplex or FRET participating molecules modified to be a chain extending diols. In the present invention the reaction that forms the exciplex-based polyurethane is the addition of a total isocyanate to hydroxyl molar ratio (NCO:OH) ranging from 1 to 2 and a “mix” consisting of the chain extending diols and polyol in a molar ratio (diols to polyol) ranging from 10:1 to 1:2.

The composition of the polyacrylates includes (but are not limited to) butyl acrylate (BA), methyl methacrylate (MMA), and exciplex or FRET participating molecules modified for acrylate polymerization. Typical BA weight percents of BA in this invention range from 20 to 90%. The remaining weight fraction may be made up of MMA and exciplex forming acrylate monomers. Compared to the amount of exciplex forming acrylate monomers required to produce a detectable optical signal only a minute amount of FRET forming acrylate dyes is needed in the acrylate synthesis (on the order of 1 milligram dye per 10 grams polymer).

In both the polyurethane and the polyacrylate compositions described above all constituents of the photochemical system are incorporated into the polymer at one time in the appropriate ratio. Copolymerization of the pressure sensitive photochemical system constituents in/to the polymeric structure can be done with both constituents of a photochemical system at the same time as just described or can be done in a “one at a time” sense. If each of the photochemically participating molecules is incorporated individually to the polymer backbone the proper ratio of donor to acceptor molecules is established by the including the appropriate amount of resulting polymer solutions in the final product.

Polyurethane pressure sensitive nano-material synthesis example where each photochemical system constituent is incorporated individually, e.g. the addition of DMAD:
A monomer mix of PPO (molecular weight: 2000 grams/mole; 8 grams, 0.004 moles) and DMAD, specifically 2-(4-Dimethylaminobenzyl)-propane-1,3-diol, (molecular weight: 209.29 grams/mole; 1.672 grams, 0.008 moles) was added to a 125 ml 3 neck flask with 40 uL of dibutyl tin dilaurate (DBTDL) as catalyst. The flask was fitted with a condenser, an inlet for dry nitrogen, and an addition funnel. The flask was immersed in an oil bath and the contents were placed under a blanket of dry nitrogen. Anhydrous tetrahydrofuran (THF, 20 mL) was added through the addition funnel, and the flask was slowly heated to 70° C. At a reaction temperature of 70° C., IPDI (molecular weight: 222.29 grams/mole; 2.67 g, 0.0012 moles) and 5 mL of THF were added slowly through the addition funnel. The reaction mix was stirred for a total of 5 hours then cooled.

The basic process is repeated for incorporation of the second photochemical system constituent. The resulting polymer solutions are then mixed in the ratio appropriate for the photochemical system incorporated.

Polyacrylate pressure sensitive nano-material synthesis example where each photochemical system constituent is incorporated individually, e.g. the incorporation of Rhodamine B:
A monomer mix of BA and MMA in 70:30 weight ratio (7 grams BA, 3 grams MMA) was placed in a 3 neck 125 mL flask along with dibenzoyl peroxide (BPO, 0.5% by weight, 50 milligrams), Rhodamine B acrylate monomer, specifically Methacryloxyethyl thiocarbamoyl rhodamine B, (0.8 milligrams), and 38 mL of ethanol. The flask was fitted with a condenser and dry nitrogen inlet then placed in an oil bath. The reaction contents were slowly heated to 90° C. and the temperature was maintained for the course of the reaction. Total reaction time was 48 hours.

The basic process is repeated for incorporation of the second photochemical system constituent. The resulting polymer solutions are then mixed in the ratio appropriate for the photochemical system incorporated.

3. The final solution resulting from step 2 above is modified as required, i.e. additional additives can be incorporated including but not limited to plasticizers or other polymers. For example, short block polymers have been added to act as “spacers” increasing the “void space” in the final, cured coating. By increasing the “internal” space available, the longer chain polymer has more freedom of movement and this greatly increases the sensitivity of the coating to changes in pressure.

4. Pressure sensitive nano-materials based on polyurethanes described in the present invention are then processed as solutions capable of being sprayed. For example, the final polyurethane-based reaction mixture is diluted to a solution with a solid content of 3 to 10% (weight/volume) using solvents including tetrahydrofuran, toluene, isopropanol, and methyl ethyl ketone. The invention may include some or all of the above listed solvents (in various ratios in the formulation) to control the evaporation rate, coating thickness and quality, and solubility of the temperature sensitive chromophore.

The processing of acrylate based formulations in this invention are similar to the polyurethanes. The final polyacrylate-based reaction mixture described above is diluted to a solid content of 5 to 10% (weight/volume) using solvents including ethanol, isopropanol, methyl ethyl ketone, acetone, and toluene. The invention may include some or all of the above listed solvents (in various ratios in the formulation) to control the evaporation rate, coating qualities and solubility of the temperature sensitive chromophore.

5. A temperature sensitive chromophore is selected based on its optical properties (both excitation and emission wavelengths as well as quantum efficiency), solubility in the polymer solutions resulting from the steps above and temperature sensitivity when encapsulated in a polymer coating. For example, a Europium complex such as Europium (III) Thenoyltrifl (which we have called EuTTA) has an excitation wavelength compatible with anthracene derivatives used in our exciplex-based systems and an emission spectrum centered at 614 nm “red” which provides for adequate optical isolation during signal detection. It is also soluble in the polyurethane-based polymer solutions produced above. EuTTA exhibits excellent temperature sensitivity when encapsulated in polyurethanes, e.g. 100 counts per degree Celsius when detected with a 16-bit system. Currently 20 mg of EuTTA is added to 10 ml of polymer solution. Alternatively, a Tris (2,2′-bipyridyl) dichloro-ruthenium (II) hexahydrate, which has an excitation wavelength compatible with the perylene and aniline derivatives used in our exciplex-based systems, and with the Fluorescein and Rhodamine B derivatives used in our FRET-based systems, centered at 435 nm “blue” has been used. Similar to the Europium (III) Thenoyltrifl, Tris (2,2′-bipyridyl) dichloro-ruthenium (II) hexahydrate emits at roughly 610 nm and provides for adequate optical isolation during signal detection. Currently 1 gram of Tris (2,2′-bipyridyl) dichloro-ruthenium (II) hexahydrate is added to about 1.5 liters of polyacrylate solution.

6. The formulations in this invention can be sprayed using conventional air powered spraying equipment in the range of 15 to 40 psi.

### Advantages Over the Prior Art

The prior art material with respect to Gouterman et al exploits the photochemical process of dynamic quenching by oxygen to vary the emission light intensity with changes in pressure. The reliance upon the oxygen limits existing pressure sensitive paints to operation in air. In addition, it contributes to the overall sensitivity of the material. The prior art material with respect to Kelly et al. exploits photochemical systems and focuses on the use of these systems exclusively in polystyrene, which limits the useful range of application. By using the materials disclosed herein, Applicant has overcome the limitation associated with polystyrene without incurring a penalty associated with oxygen. In the preferred embodiment of the invention, a photochemical system, i.e. exciplex or fluorescence resonance energy transfer (FRET) and a temperature sensitive compound, are exploited to remove the reliance on oxygen for pressure sensitivity. Both the exciplex and FRET systems combined with temperature sensitive compounds provide a rapid response to changes in pressure and temperature. In addition, the compressibility of the material with the exciplex and FRET system is reversible and not adversely affected by temperature over the typical operating range. Accordingly, the removal of the reliance on oxygen as a contributor to detecting changes in pressure provides an improved response time as well as enhances sensitivity in application of the material.

The donor molecules and excited state complex, or the donor and acceptor molecules, associated with sensing pressure in the combined pressure and temperature sensitive material formulation emit at different wavelengths. As pressure increases, emission from the donor molecules decreases and emission from the excited state complex or acceptor molecules increases. Thus, although changes in the intensity of emission from the acceptor molecules alone could be used to determine the corresponding changes in pressure (analogous to the use of traditional pressure sensitive paint), changes in the ratio of the intensity of emission from the excited state complex or acceptor molecules relative to the donor molecules is still greater. That is, division of the increasing value of emission intensity of the excited state complex or acceptor molecules by the decreasing value of emission intensity of the donor molecules results in a ratio of greater value than the value of the emission intensity of the donor molecules by itself. The ratioing of two simultaneously acquired signals (the two emission wavelengths) eliminates the requirement for a ‘reference’ intensity overcoming that limitation of traditional pressure sensitive paints. In addition, the positive relationship between emission intensity and pressure eliminates the disadvantages presented by the inverse relationship between emission intensity and pressure due to the dynamic quenching of traditional pressure sensitive paints. And, the positive relationship between emission intensity and pressure in this combined temperature and pressure sensitive coating enhances the achievable signal-to-noise ratio in new or existing pressure or temperature sensitive paint systems.

Of the two formulations, comprised of one of the new pressure sensitive nano-material formulations and an additional temperature sensitive chromophore, the first takes advantage of the exciplex-based pressure sensitive formulation comprised of the anthracene/aniline system coupled with a temperature sensitive Europium complex, specifically Europium (III) Thenoyltrifl. These constituents are compatible in a number of solvents and a common polymer. They can all be excited at a single wavelength, i.e. 365 nm. And the spectral separation between the emission wavelengths; 400 nm, 510 nm and 614 nm, makes optical filtering for signal acquisition easy. The second formulation takes advantage of the FRET-based pressure sensitive formulation comprised of the Fluorescein/Rhodamine B system described above coupled with a temperature sensitive Ruthenium complex, specifically tris-(2,2′-bipyridine) ruthenium(II) chloride hexahydrate. These constituents are also compatible in a number of solvents and a common polymer. They can all be excited at a single wavelength, e.g. 435 nm. The spectral separation between the emission wavelengths; 515 nm, 575 nm and 640 nm, also makes optical filtering for signal acquisition easy. The photochemical phenomena associated with these new formulations occurs on the microscopic level, so that these combined pressure and temperature sensitive formulations are truly nano-materials.

In addition to improvements in material properties such as durability and extending the operating range of the sensor to environments without oxygen, e.g. nitrogen, the simultaneous acquisition of pressure and temperature data allows more accurate temperature corrections to be applied to the measured pressures everywhere the coating is applied, without the use of any secondary temperature measurements. In addition, the material operates over a wide temperature range overcoming the limitation of prior temperature compensating pressure sensitive paints. Similar to the processes previously used, an analogous process for temperature correction can be utilized thus enabling use of the combined pressure and temperature sensitive material in existing pressure and temperature sensitive paint systems.

### Alternative Embodiments

It will be appreciated that, although specific embodiments of the invention have been described herein for purposes of illustration, various modifications may be made without departing from the spirit and scope of the invention. In particular, other types of distance dependent photochemical systems or materials used as host matrices or components of host matrices may be implemented into the pressure sensitive material. Similarly other temperature sensitive compounds may be used to implement the temperature sensing component of the material. Accordingly, the scope of protection of this invention is limited only by the following claims and their equivalents.

1. A composition comprising a polyurethane formed from prescursors comprising polyol, an aliphatic diisocyanate, and an exciplex or FRET system; and a temperature sensitive chromophore which exhibits an optically detectable response to change in temperature; wherein said exciplex or FRET contains an analog or homolog, wherein said analog or homolog contains a functional group, wherein said functional group reacts with either said polyurethane or its prescursors, wherein said composition exhibits an optically detectable response to changes in pressure and temperature.

2. The composition of claim 1, wherein said aliphatic diisocyanate is selected from a group consisting of: isophorone diisocyanate (IPDI), and diisocyanate hexamethylene (HDI).

3. The composition of claim 1, wherein said polyol is a diol selected from a group consisting of: polypropylene glycol (PPG), and polytetramethylene glycol (PTMO or PTMEG).

4. The composition of claim 1, wherein said temperature sensitive chromophore comprises a metal selected from a group consisting of: Ruthenium, Europium, Pyronin, Platinum, and Chromium.

5. The composition of claim 1, wherein said temperature sensitive chromophore is selected from a group consisting of: organic and inorganic.

6. The composition of claim 1, wherein said temperature sensitive chromophore is a compound selected from a group consisting of: a fluorescent compound and a phosphorescent compound.

7. A coating on a surface, wherein the coating includes a temperature sensitive chromophone to exhibit an optically detectable response to changes in pressure and temperature, and wherein said coating is formed from a solution of polyol, an aliphatic diisocyanate, and an exciplex or FRET system; wherein said exciplex or FRET contains an analog or homolog, wherein said analog or homolog contains a functional group, wherein said functional group reacts with either said polyurethane or its prescursors.

8. The coating of claim 7, wherein said aliphatic diisocyanate is selected from a group consisting of: isophorone diisocyanate (IPDI), and diisocyanate hexamethylene (HDI).

9. The coating of claim 7, wherein said polyol is a diol selected from a group consisting of: polypropylene glycol (PPG), and polytetramethylene glycol (PTMO or PTMEG).

10. The coating of claim 7, wherein said temperature sensitive chromophore comprises a metal selected from a group consisting of: Ruthenium, Europium, Pyronin, Platinum, and Chromium.

11. The coating of claim 7, wherein said temperature sensitive chromophore is selected from a group consisting of: organic and inorganic.

12. The coating of claim 7, wherein said temperature sensitive chromophore is a compound selected from a group consisting of: a fluorescent compound and a phosphorescent compound.

13. A surface coated with a composition comprising: a polyurethane formed from prescursors comprising polyol, an aliphatic diisocyanate, and an exciplex or FRET system, wherein said exciplex or FRET contains an analog or homolog, wherein said analog or homolog contains a functional group, wherein said functional group reacts with either said polyurethane or its prescursors, wherein said composition includes a temperature sensitive chromophore to exhibit an optically detectable response to changes in pressure and temperature.

14. The surface coated composition of claim 13, wherein said aliphatic diisocyanate is selected from a group consisting of: isophorone diisocyanate (IPDI), and diisocyanate hexamethylene (HDI).

15. The surface coated composition of claim 13, wherein said polyol is a diol selected from a group consisting of: polypropylene glycol (PPG), and polytetramethylene glycol (PTMO or PTMEG).

16. The surface coated composition of claim 13, wherein said temperature sensitive chromophore comprises a metal selected from a group consisting of: Ruthenium, Europium, Pyronin, Platinum, and Chromium.

17. The surface coated composition of claim 13, wherein said temperature sensitive chromophore is selected from a group consisting of: organic and inorganic.

18. The surface coated composition of claim 13, wherein said temperature sensitive chromophore is a compound selected from a group consisting of: a fluorescent compound and a phosphorescent compound.

19. A composition comprising a polyacrylate formed from any one of: butyl acrylate or methyl methacrylate; an analog or homolog of an exciplex or FRET, wherein said analog or homolog contains a functional group, wherein said functional group reacts with said polyacrylate, wherein said composition includes a temperature sensitive chromophore to exhibit an optically detectable response to changes in pressure and temperature.

20. The composition of claim 19, wherein said temperature sensitive chromophore comprises a metal selected from a group consisting of: Ruthenium, Europium, Pyronin, Platinum, and Chromium.

21. The composition of claim 19, wherein said temperature sensitive chromophore is selected from a group consisting of: organic and inorganic.

22. The composition of claim 19, wherein said temperature sensitive chromophore is a compound selected from a group consisting of: a fluorescent compound and a phosphorescent compound.

23. A coating on a surface, wherein the coating includes a temperature sensitive chromophore to exhibit an optically detectable response to changes in pressure and temperature, and wherein said coating is formed from a solution of a composition comprising polyacrylate formed from any one of: butyl acrylate or methyl methacrylate; an analog or homolog of an exciplex or FRET, wherein said analog or homolog contains a functional group, wherein said functional group reacts with said polyacrylate

24. The coating of claim 23, wherein said temperature sensitive chromophore comprises a metal selected from a group consisting of: Ruthenium, Europium, Pyronin, Platinum, and Chromium.

25. The coating of claim 23, wherein said temperature sensitive chromophore is selected from a group consisting of: organic and inorganic.

26. The coating of claim 23, wherein said temperature sensitive chromophore is a compound selected from a group consisting of: a fluorescent compound and a phosphorescent compound.

27. A surface coated with a composition comprising: a polyacrylate formed from any one of: butyl acrylate or methyl methacrylate; an analog or homolog of an exciplex or FRET, wherein said analog or homolog contains a functional group, wherein said functional group reacts with said polyacrylate, wherein said composition includes a temperature sensitive chromophore to exhibit an optically detectable response to changes in pressure and temperature.

28. The surface coated composition of claim 27, wherein said temperature sensitive chromophore comprises a metal selected from a group consisting of: Ruthenium, Europium, Pyronin, Platinum, and Chromium.

29. The surface coated composition of claim 27, wherein said temperature sensitive chromophore is selected from a group consisting of: organic and inorganic.

30. The surface coated composition of claim 27, wherein said temperature sensitive chromophore is a compound selected from a group consisting of: a fluorescent compound and a phosphorescent compound.
